(19) United States
(12) Patent Application Publication
(10) Pub. No.: US 2008/0202567 A1
(43) Pub. Date: Aug. 28, 2008

(54) Multi Function Cleaner

(76) Inventor: Hae Sung Jung, Boryeong-Si Chungnam (KR)

Correspondence Address: IPLA P.A., 3580 WILSHIRE BLVD., 17TH FLOOR, LOS ANGELES, CA, 90010, US

(21) Appl. No.: 12/065,978

(22) PCT Filed: Sep. 6, 2006
(86) PCT No.: PCT/KR06/03546

§ 371 Date: Mar. 6, 2008

(30) Foreign Application Priority Data
Sep. 7, 2005 (KR) 10-2005-0083286

(51) Int. Cl. B08B 3/04; A47L 13/26; D06F 75/06; A47L 25/00; B08B 13/00; A47L 13/00

(52) U.S. Cl. 134/115 R; 15/209.1; 15/118

(57) ABSTRACT

A multi-functional cleaner is disclosed. In the multi-functional cleaner of the present invention, a heating chamber (40), in which a heating plate (41) is provided, is defined below a water supply tank (30), which is installed between a main body (10) and a cover (20). A stop cap (50) is fitted over a steam discharge duct (31) of the water supply tank (30). A hollow steam guide duct (11) is provided in the steam discharge duct (31) at a position spaced apart from the steam discharge duct (31), and the steam guide duct communicates with a branch duct provided in the main body. A display panel and a subsidiary power supply connector are provided at predetermined positions in the upper surface of the cover. A handle connector (60), into which a handle rod (63) is fitted, is coupled to opposite ends of the cover using removable coupling hinges (61).

### TECHNICAL FIELD

The present invention relates, in general, to multi-functional cleaners and, more particularly, to a multi-functional cleaner which discharges downwards high-temperature steam generated by boiling water, which is supplied from a water supply tank into a heating chamber, using the heat of a heating plate provided at a lower position in the heating chamber, thus loosening foreign substances attached to the floor such that they can be easily removed, and in which, when the multi-functional cleaner does not conduct a steam-cleaning function, the multi-functional cleaner may be selectively used as a steam half-tub, a steam iron or a humidifier by discharging steam upwards, thus increasing the usefulness of the steam cleaner.

### BACKGROUND ART

Generally, to remove foreign substances, such as dust, hair, hardened greasy dirt, etc., stuck to a floor, a user wipes the floor with a dustcloth, which has been clearly washed. After some foreign substances have been removed, the user washes the dustcloth, to which the removed foreign substances are stuck, and, thereafter, places the dustcloth on the remaining foreign substances on the floor and scrubs the remaining foreign substances with the dustcloth several times.

In the case where a relatively short time has passed since the floor became smeared with dust or greasy dirt, the substances may be easily removed. However, in the case where a long time has passed since the event occurred, it is very difficult to remove the substances.

Furthermore, there is an inconvenience in that the user must wash the dustcloth and use it to wipe a desired area several times even when the desired area is small. In an effort to overcome the above-mentioned inconveniences, a mop, which is constructed such that the user can wash and squeeze a sponge thereof without requiring contact between his/her hands and the sponge before wiping a floor with the sponge, was proposed. However, this mop has a problem in that, because relatively low-temperature water is used, foreign substances are not easily removed.

To solve the above-mentioned problems, a steam cleaner was proposed in Korean Utility Model Application No. 1999-43562 (Oct. 4, 1999). The proposed steam cleaner is constructed such that steam generated by electrodes is discharged outside through a dustcloth, thus sterilizing the floor, and activating the surfaces of the objective foreign substances, thereby easily removing the foreign substances even when the floor is smeared with greasy dirt that is not easily removed. However, there is a disadvantage in that, because the expensive steam cleaner is used only for cleaning, the usefulness thereof is low.

To solve the problem of the reduced efficiency of the steam cleaner, a steam cleaner, which has a steam humidifying function, was proposed in Korean Utility Model Registration No. 282793 (Jul. 9, 2002). In normal times, the steam cleaner is used to remove foreign substances from a floor. When the steam cleaner is not being used for cleaning, a steam hose is hung on a hook part, so that the steam cleaner can be used as a humidifier. However, this steam cleaner has no additional function other than the function as the humidifier, and has an inconvenience in that the direction in which steam is discharged from the steam hose cannot be changed.

Meanwhile, a steam cleaner having a function of a steam iron was proposed in Korean Utility Model Registration No. 379547 (Mar. 11, 2005). This steam cleaner is controlled such that steam is supplied into an ironing pad both through a steam hose support part, which is coupled to a main body having a steam generator, and through a steam hose. In this case, the steam cleaner is used to iron creases of clothes hung on cloth hangers and to sterilize a vertical curtain. Furthermore, a brush or a dustcloth member may be removably coupled to the ironing pad, so that it can be used to sterilize windows, furniture and walls of the room, and to remove hardened dirt. However, because a rotating part provided with a handle stick is fastened to the main body such that they cannot be separated from each other, the steam cleaner is inconvenient to store. Because the purposes of the steam cleaner are limited to cleaning, sterilization and ironing, the usefulness thereof is also low.

### DISCLOSURE OF INVENTION

### Technical Problem

Accordingly, the present invention has been made keeping in mind the above problems occurring in the prior art, and an object of the present invention is to provide a multi-functional cleaner which discharges downwards high-temperature steam generated by boiling water, which is supplied from a water supply tank into a heating chamber, using the heat of a heating plate provided at a lower position in the heating chamber, thus easily removing foreign materials from floors using steam, and in which, when the multi-functional cleaner does not conduct a steam-cleaning function, the multi-functional cleaner may be selectively used as a steam half-tub, a steam iron or a humidifier by changing the direction in which steam is discharged, thus increasing the usefulness of the steam cleaner.

### Technical Solution

In order to accomplish the above object, the present invention provides a multi-functional cleaner to generate steam, including: a main body having a steam guide duct and coupled to a lower end of a cover; a dustcloth plate attached to a lower surface of the main body; the cover, having a display panel to display an amount or a temperature of water and power, and a subsidiary power supply connector; a water supply tank provided between the main body and the cover and provided with a steam discharge duct, which protrudes upwards outside an upper surface of the water supply tank and is spaced apart from the steam guide duct in a diametrical direction by a predetermined distance; a heating chamber defined below the water supply tank and having a heating plate therein; and a stop cap coupled to the steam discharge duct, wherein a lower end of the steam guide duct is connected to a branch duct provided at a lower position in the main body, so that steam generated in the heating chamber is supplied into the dustcloth plate through the steam discharge duct, the steam guide duct and the branch duct.

The stop cap may have a shape, which is open at a lower end thereof, an internal thread may be formed on a circumferential inner surface of the stop cap, a sealing pad may be provided at an upper end of the internal thread in the stop cap, an extension rod, which extends a predetermined length downwards, may be integrally provided at a central position under an inner surface of the stop cap which is adjacent to the upper end of the internal thread, and a lower part of the extension rod may be increased in diameter towards a lower end thereof to have a diameter equal to an inner diameter of the steam discharge duct.

The multi-functional cleaner may further include a handle connector coupled to opposite ends of the cover using removable coupling hinges, with a coupling hole formed in the handle connector so that a handle rod is inserted into the coupling hole. Each of the removable coupling hinges may include a hinge pin, over which a coil spring is fitted, and which is inserted into a hinge pin insert hole that has a stepped shape and is formed in each of arms provided on opposite ends of the handle connector, the hinge pin having a holding part on a first end thereof and having an insert end on a second end thereof, a compression ring integrally provided on the hinge pin at a position adjacent to the insert end, and a removal prevention ring fitted into the hinge pin insert hole, into which the hinge pin is inserted, so that the insert end, which is exposed outside the removal prevention ring, is inserted into each of hinge holes formed in the cover.

The stop cap coupled to the steam discharge duct may comprise a steam guide cap connected to a first end of a guide hose, and a half-tub or an iron may be connected to a second end of the guide hose. The steam guide cap may have a shape which is open at opposite ends thereof, an internal thread may be formed on a circumferential inner surface of the steam guide cap, a sealing pad may be provided on an upper end of the internal thread in the steam guide cap, a hollow hose connection nipple may be provided through an upper end of the steam guide cap, a plurality of extension rods, which extend predetermined lengths downwards and are spaced apart from each other at regular angular intervals, may be provided at a central portion under an inner surface of the steam guide cap which is adjacent to an upper end of the internal thread, and a steam interruption disk may be integrally provided under lower ends of the extension rods.

The half-tub may include a tub body having a box shape, which is open at an upper end thereof, with a tub cover coupled to an upper end of the tub body using hinges, a steam dispersion pipe having a plurality of discharge holes and provided along a perimeter of a bottom of the tub body while an inlet of the steam dispersion pipe is exposed outside an insertion hole, which is formed at a lower position through the tub body, and is connected to the guide hose, a footstep placed inside the steam dispersion pipe in the tube body, and a control unit having a temperature controller provided on the tube body, the control unit being connected to the subsidiary power supply connector provided in the cover.

The iron may include an iron body provided with a handle, and a steam storage body installed in the iron body. A plurality of steam discharge holes may be formed through lower surfaces of the iron body and the steam storage body, and each of the steam discharge holes has a shape which is increased in diameter from an upper position to a lower position thereof.

The stop cap coupled to the steam discharge duct may comprise a steam guide cap having a shape which is open at a lower end thereof. An internal thread may be formed on a circumferential inner surface of the steam guide cap, a sealing pad may be provided on an upper end of the internal thread in the steam guide cap, a joint socket, having a hollow shape that is increased in diameter to an intermediate position thereof, may be provided on an upper surface of the steam guide cap, and a joint ball provided with a nozzle may be inserted into the joint socket.

### Advantageous Effects

The present invention provides a multi-functional cleaner which discharges downwards high-temperature steam generated by boiling water, which is supplied from a water supply tank into a heating chamber, using the heat of a heating plate provided at a lower position in the heating chamber, thus easily removing foreign materials from the floor using steam. Furthermore, when the multi-functional cleaner does not conduct a steam-cleaning function, the multi-functional cleaner may be selectively used as a steam half-tub, a steam iron or a humidifier by changing the direction in which steam is discharged, thus increasing the usefulness of the steam cleaner.

### BRIEF DESCRIPTION OF THE DRAWINGS

FIG. 1 is a perspective view of a multi-functional cleaner according to the present invention;

FIG. 2 is a longitudinal sectional view of the multi-functional cleaner according to the present invention; and

FIG. 3 is an exploded perspective view of a removable coupling hinge of the multi-functional cleaner according to the present invention;

FIG. 4 is an exploded perspective view illustrating the construction of a steam discharge duct and a stop cap of the multi-functional cleaner according to the present invention;

FIG. 5 is a longitudinal sectional view showing a steam guide cap coupled to the multi-functional cleaner to discharge steam outside from the cleaner, according to the present invention;

FIG. 6 is an exploded perspective view of a half-tub, into which steam is supplied from the steam guide cap coupled to the multi-functional cleaner, according to the present invention;

FIG. 7 is a sectional view showing the half-tub according to the present invention;

FIG. 8 is a perspective view of the steam guide cap, which guides steam generated in the cleaner outside, according to the present invention;

FIG. 9 is a schematic view showing a control valve, which adjusts the feeding rate of steam, which has been generated in the cleaner according to the present invention;

FIG. 10 is a longitudinal sectional view illustrating an iron, into which steam generated in the cleaner is supplied, according to the present invention;

FIG. 11 is a perspective view of another steam guide cap, which guides steam generated in the cleaner outside, according to the present invention; and

FIG. 12 is a longitudinal sectional view of the steam guide cap, which guides steam generated in the cleaner outside, according to the present invention.

### BEST MODE FOR CARRYING OUT THE INVENTION

Hereinafter, a preferred embodiment of the present invention will be described in detail with reference to the attached drawings.

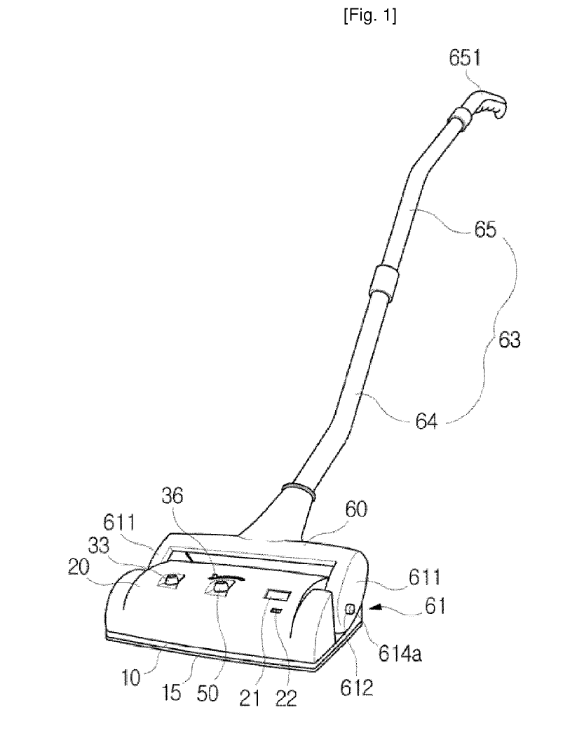

A multi-functional cleaner according to the present invention conducts cleaning and ironing, is used as a half-tub, and serves as a humidifier using steam generated by heating water supplied from a water supply tank 30 in a heating chamber 40. As shown in FIGS. 1 through 4, the multi-functional cleaner includes a main body 10, a cover 20, the water supply tank 30, the heating chamber 40, a stop cap 50 and a handle connector 60.

The main body 10 is constructed such that a dustcloth plate 15 can be removably attached to a lower surface of the main body 10 using velcro tape 14 and such that the heating chamber 40, having a heating plate 41 therein, is provided thereabove.

Furthermore, opposite ends of the main body 10 are coupled to respective opposite ends of the cover 20 using a plurality of screws 13. A branch duct 12 having a pre-determined space is provided in a lower part of the main body 10, so that steam generated in the heating chamber 40 is appropriately supplied to the entire surface of the dustcloth plate 15.

A hollow steam guide duct 11, which is open at an upper end thereof and is reduced in width from the lower end to the upper end, is provided at the central position in the main body 10 at a predetermined height, thus preventing boiling water from overflowing while a user holds a handle cushion 651 provided on a movable rod 65 and conducts a cleaning process.

The cover 20 prevents the water supply tank 30, which is placed on the main body 10, from being exposed outside and undesirably separated from the main body 10. In addition, a handle rod 63 is coupled to the cover 20 such that the user can easily move the cleaner.

For this, the lower end of the cover 20 is coupled to the lower part of the main body 10 using the screws 13, as described above. The water supply tank 30 is provided between the cover 20 and the main body 10.

Furthermore, a water supply port 32 protrudes upwards from the water supply tank 30 at a predetermined position and is exposed outside the upper surface of the cover 20. A water supply port cap 33 is removably fitted over the water supply port 32. As well as the water supply port 32, a steam discharge duct 31, which is provided on a central portion of the upper surface of the water supply tank 30 and will be explained in detail later herein, is exposed outside the upper surface of the cover 20. The stop cap 50 or a steam guide cap 70 is fitted over the exposed steam discharge duct 31, as selected by the user.

A display panel 21, which displays the temperature of steam, the amount of water, the amount of generated steam, and power, and a subsidiary power supply connector 22 are provided at predetermined positions on the upper surface of the cover 20 and are connected to a control panel, which is not shown. The handle connector 60 is coupled to the cover 20 at opposite ends thereof by removable coupling hinges 61. A lower end of a support rod 64 of the handle rod 63 is fitted into a coupling hole 62 formed in the handle connector 60.

The heating chamber 40 is a space defined below the water supply tank 30 and above the main body 10. The heating plate 41, which is connected to an output of the control panel, is disposed at a lower position in the heating chamber 40 to rapidly heat water, which is supplied at a predetermined rate through a supply passage 34 formed through the lower surface of the water supply tank 30, thus generating steam. In detail, the supply passage 34 is defined to have a shape which extends a predetermined length from the lower surface of the water supply tank 30 towards the heating chamber 40, so that water is prevented from being supplied into the heating chamber 40 to a height higher than the lower end of the supply passage 34.

The water supply tank 30 stores therein water supplied from the outside and is constructed such that the water is automatically supplied into the heating chamber 40 in an amount corresponding to the amount of water lost by being changed into steam, and such that some or all of the steam generated in the heating chamber 40 can be supplied below the lower part of the main body 10 or the upper part of the cover 20.

To achieve the above purposes, the water supply port 32, which is covered with the water supply port cap 33, is provided at a predetermined position through the upper surface of the water supply tank 30, and the steam discharge duct 31, which is open at an upper end thereof, is provided at the central position in the water supply tank 30 in an arrangement such that it is spaced apart from the steam guide duct 11 of the main body 10 at a predetermined distance.

Furthermore, the steam discharge duct 31 has a shape such that the lower part thereof increases in diameter from an upper position to a lower position and an upper part thereof has a pipe shape that is constant in diameter. The pipe-shaped part of the steam discharge duct 31 protrudes outside the upper surface of the water supply tank 30. An external thread is formed around the upper end of the pipe-shaped part of the steam discharge duct 31 such that the stop cap 50 or the steam guide cap 70 can be threaded onto the upper end of the pipe-shaped part.

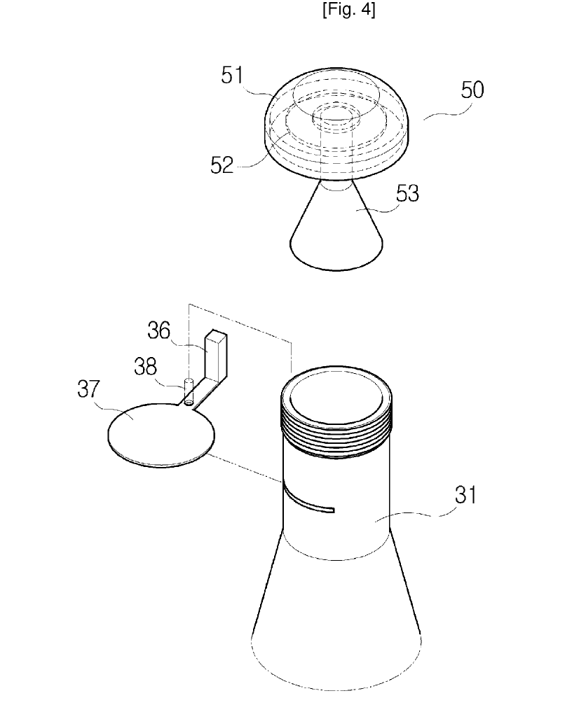

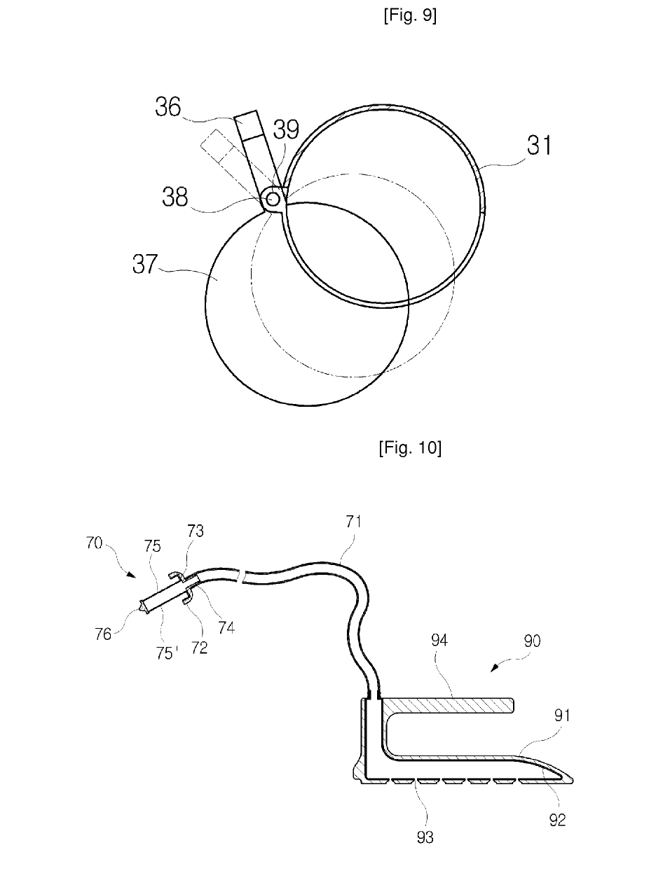

In addition, as shown in FIGS. 4 and 9, an adjustment plate 37 provided with a lever 36 is coupled to the steam discharge duct 31 using a pin 38 inserted into a pin hole 39, so that the cross-sectional area of the steam discharge duct 31 can be adjusted using the adjustment plate 37. Thereby, the amount of steam discharged outside through the steam discharge duct 31 is adjusted.

The stop cap 50 is coupled to the steam discharge duct 31, which is provided at the central position in the water supply tank 30 and extends from the lower surface of the water supply tank 30 outside the upper surface thereof, such that almost all of the steam generated in the heating chamber 40 can be supplied below the main body 10 through the steam guide duct 11 and the branch duct 12, and thus can be used in steam-cleaning. As shown in FIG. 4, the stop cap 50 has a shape such that only the lower end thereof is open. An internal thread 51 is formed on the circumferential inner surface of the stop cap 50. A sealing pad 52 is provided at the upper end of the internal thread 51 in the stop cap 50. An extension rod 53, which extends a predetermined length downwards, is integrally provided at the central position under the inner surface of the stop cap 50 that is adjacent to the upper end of the internal thread 51.

A lower part of the extension rod 53 has a shape that is increased in diameter from an upper position to a lower position thereof and has the same diameter as the inner diameter of the steam discharge duct 31, thus reliably preventing steam from being discharged outside. Furthermore, the lower end of the extension rod 53 is disposed adjacent to the upper end of the steam guide duct 11, so that steam moved from the heating chamber 40 to an upper position thereof is directly drawn into the steam guide duct 11.

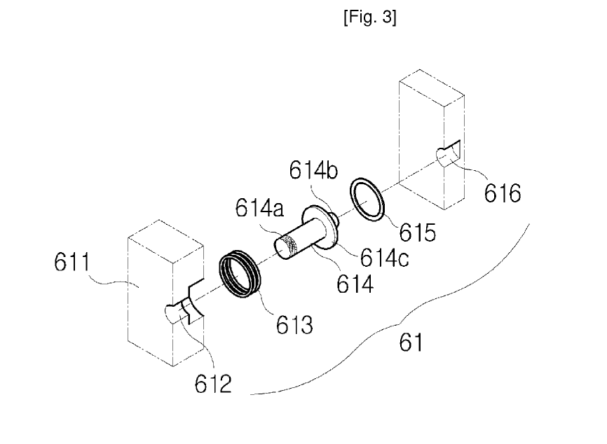

The removable coupling hinges 61 are constructed such that, when the user desires to conduct the steam-cleaning, the handle connector 60 coupled to the handle rod 63 can be coupled to the cover 20 through the removable coupling hinges 61, and, when the user desires to use the cleaner as a half-tub, while ironing, or as a humidifier, the handle connector 60 can be easily removed from the cover 20. For this, as shown in FIG. 3, a hinge pin insert hole 612, which has a stepped shape, is formed in each of the arm parts 611, which are provided on the respective opposite ends of the handle connector 60, and a hinge pin 614, over which a coil spring 613 is fitted, is inserted into each hinge pin insert hole 612.

Furthermore, each hinge pin 614 has a holding part 614a on an end thereof and has an insert end 614b on the other end thereof. A compression ring 614c is integrally provided on the hinge pin 614 at a position adjacent to the insert end 614b.

In addition, a removal prevention ring 615 is fitted into the hinge pin insert hole 612, into which the hinge pin 614 is inserted, thus preventing the hinge pin 614 from being lost by being undesirably removed backwards out of the hinge pin insert hole 612. The insert end 614b, which is exposed outside the removal prevention ring 615, is inserted into an associated hinge hole 616, which is formed in the cover 20.

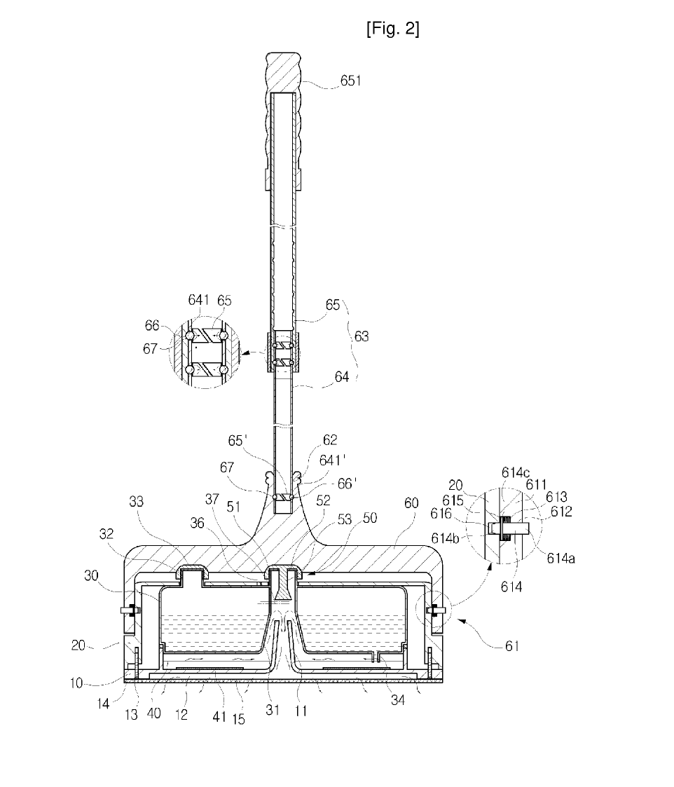

The handle rod 63 is constructed such that the length thereof can be adjusted for convenience depending on the height of the user. As shown in FIGS. 1 and 2, the handle rod 63 includes the support rod 64, which is inserted into the coupling hole 62, and the movable rod 65, which is coupled to the support rod 64.

The support rod 64 has a hollow shape. Through holes 641 and 641′ are formed through respective opposite ends of the sidewall of the support rod 64. Balls 66 and 66′, which are elastically supported by ring spring 65 and 65′, are seated into the respective through holes 641 and 641′ such that parts of the balls 66 and 66′ are exposed outside the through holes 641 and 641′ by the elasticity of the ring spring 65 and 65′.

Furthermore, the protruding parts of the balls 66 and 66′, which are provided in the upper and lower ends of the support rod 64, are inserted into respective stop grooves 67 and 67′, which are formed in the circumferential inner surfaces of the movable rod 65 and the coupling hole 62. Therefore, when the support rod 64 is inserted into the coupling hole 62, the ball 66′, which is elastically biased outwards by the ring spring 65′, is fitted into the stop groove 67′, so that the support rod 64 is fastened to the handle connector. The movable rod is fastened to the support rod 64 at a desired position by fitting the ball 66 into the desired stop groove 67 using the elasticity of the ring spring 65.

In the present invention, a single set of ball and ring springs associated with the movable rod 65 is illustrated, but, as shown in FIG. 2, several balls and several ring springs may be provided. In this case, the locking force or a coupling force between the support rod 64 and the movable rod 65 is increased, so that the support rod 64 is prevented from being undesirably inserted into the movable rod 65 when the user holds and pushes the handle cushion 651.

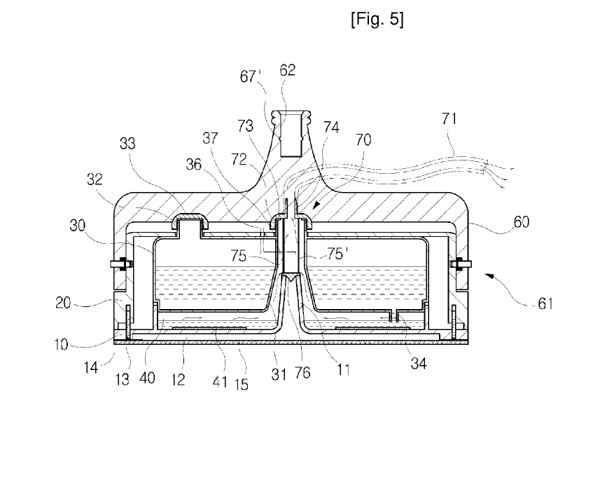

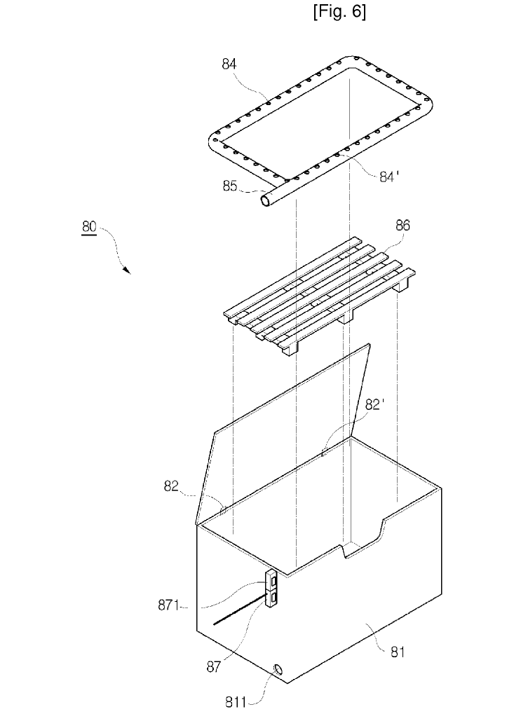

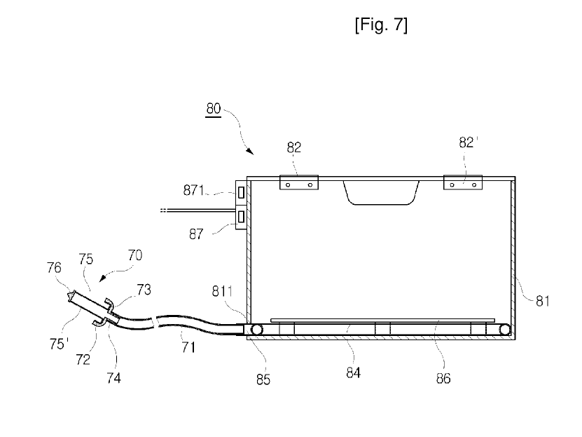

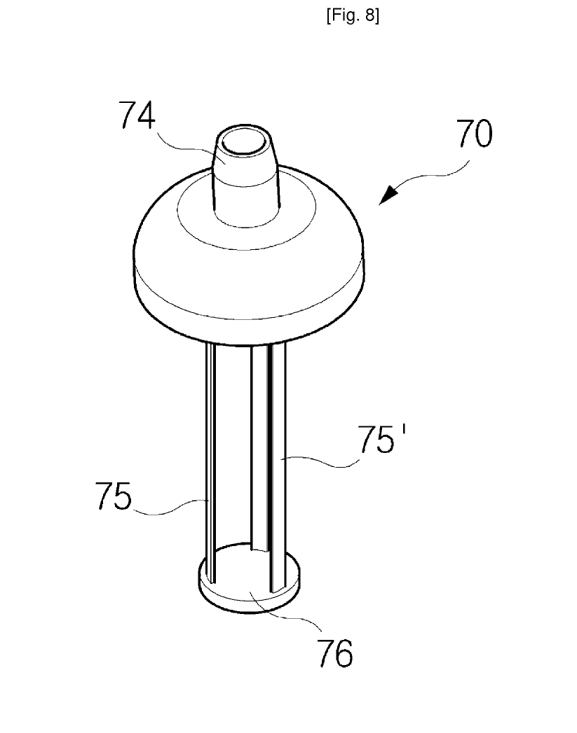

Meanwhile, FIG. 5 is a longitudinal sectional view showing a steam guide cap coupled to the multi-functional cleaner to discharge steam outside from the multi-functional cleaner, according to the present invention. FIG. 6 is an exploded perspective view of a half-tub, into which steam is supplied from the steam guide cap coupled to the multi-functional cleaner, according to the present invention. FIG. 7 is a sectional view showing the half-tub according to the present invention. FIG. 8 is a perspective view of the steam guide cap, which guides steam generated in the cleaner outside, according to the present invention. FIG. 9 is a schematic view showing a control valve, which adjusts the feeding rate of steam that has been generated in the cleaner according to the present invention.

As shown in the drawings, in the case where the present invention is used as a half-tub but not as a steam cleaner, the steam guide cap 70 is coupled to the steam discharge duct 31. Furthermore, a guide hose 71 is coupled to the steam guide cap 71, so that steam generated in the heating chamber 40 is directly supplied to the half-tub 80.

To achieve the above purpose, the steam guide cap 70 has a shape which is open at opposite ends thereof, and an internal thread 72 is formed on the circumferential inner surface of the steam guide cap 70. A sealing pad 73 is provided on the upper end of the internal thread 72 in the steam guide cap 70. A hollow hose connection nipple 74 is provided through the upper end of the steam guide cap 70. Several extension rods 75 and 75′, which extend predetermined lengths downwards and are spaced apart from each other at regular angular intervals, are provided in a central portion under the inner surface of the steam guide cap 70 which is adjacent to the upper end of the internal thread 72. A steam interruption disk 76 is integrally provided under the lower ends of the extension rods 75 and 75′, so that all of the steam generated in the heating chamber 40 can be supplied into the half-tub 80 without being supplied below the main body 10.

Meanwhile, the half-tub 80 includes a tub body 81 having a box shape, which is open at an upper end thereof. A tub cover is rotatably coupled to the tub body 81 using hinges 82 and 82′. A steam dispersion pipe 85, having a plurality of discharge holes 84 and 84′, is provided along the perimeter of the bottom of the tub body 81.

Furthermore, an inlet of the steam dispersion pipe 85 is exposed outside an insertion hole 811, which is formed at a lower position through the tub body 81, and is connected to the guide hose 71. A footstep 86 is placed inside the steam dispersion pipe 85 in the tube body 81. A control unit 87, having a temperature controller 871 provided in the tube body 81, is connected to the subsidiary power supply connector 22, which is provided in the cover 20.

FIG. 10 is a longitudinal sectional view illustrating an iron, into which steam generated in the cleaner is supplied, according to the present invention. In the state shown in the drawing, the present invention may be used in ironing but not as a steam cleaner. In this case, a steam guide cap 70 is coupled to the steam discharge duct 31. A guide hose 71 is connected to the steam guide cap 70, so that steam generated in the heating chamber 40 is supplied into the iron 90.

The iron 90 includes an iron body 91 provided with a handle 94. A steam storage body 92 is installed in the iron body 91. A plurality of steam discharge holes 93 is formed through the lower surfaces of the iron body 91 and the steam storage body 92. Each steam discharge hole 93 has a shape which is increased in diameter from an upper position to a lower position thereof.

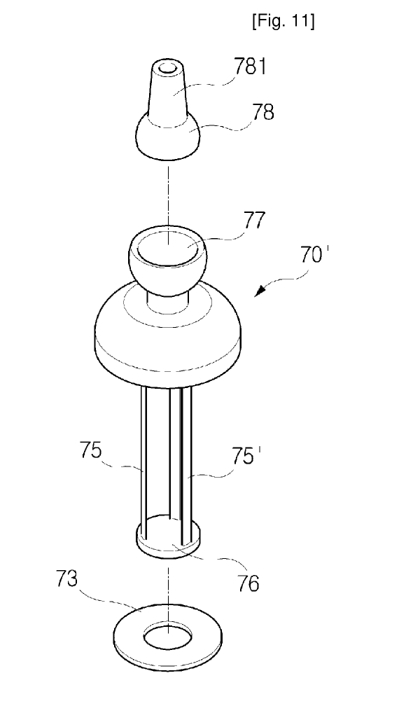

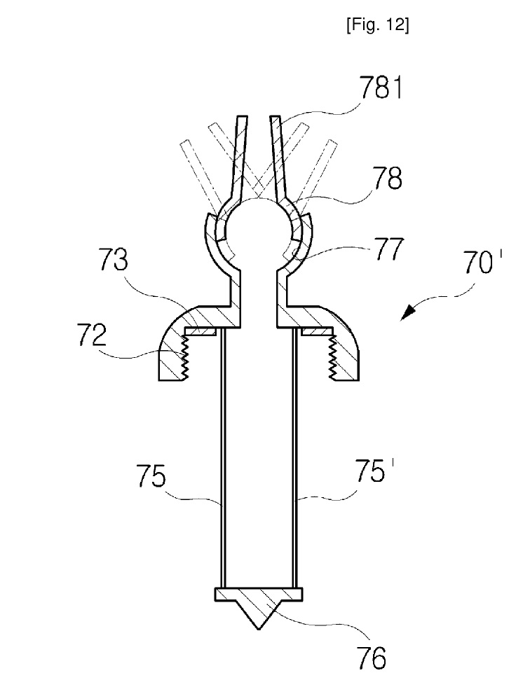

FIG. 11 is a perspective view of another steam guide cap, which guides steam generated in the cleaner outside, according to the present invention. FIG. 12 is a longitudinal sectional view of the steam guide cap, which guides steam generated in the cleaner outside, according to the present invention.

As shown in the drawings, in the case where the present invention is not used as a steam cleaner, the present invention may be provided with the steam guide cap 70′, which is used for directly discharging steam generated in the heating chamber 40 outside.

For this, the steam guide cap 70′ has a shape which is open at opposite ends thereof, and an internal thread 72 is formed on the circumferential inner surface of the steam guide cap 70′. A sealing pad 73 is provided on the upper end of the internal thread 72 in the steam guide cap 70′.

Furthermore, a joint socket 77, which has a hollow shape that increases in diameter towards the intermediate position thereof, is provided on the upper surface of the steam guide cap 70′. A joint ball 78 provided with a nozzle 781 is inserted into the joint socket 77, such that steam can be discharged in a desired direction to maintain the humidity in the room constant.

The operation of using the multi-functional cleaner having the above-mentioned construction as a steam cleaner or a humidifier or as a half-tub or when ironing will be described herein below.

When it is desired to use the present invention as a steam cleaner, the handle connector 60 is placed such that the arm parts 611, which are provided on the respective opposite ends of the handle connector 60, are disposed adjacent to the hinge holes 616, which are formed in the respective opposite ends of the cover 20. Thereafter, the handle connector 60 is pushed towards the main body 10. Then, the insert ends 614b of the hinge pins 614 are retracted into the respective removal prevention rings 615 by the opposite ends of the cover 20.

At this time, the coil springs 613, which are placed in the respective hinge pin insert holes 612, maintain the state of being compressed by the respective compression rings 614c. When parts of the insert ends 614b are aligned with the centers of the respective hinge holes 616, the insert ends 614b are advanced again from the removal prevention rings 615 by elasticity, that is, the repulsive force of the coil springs 613, and are thus inserted into the respective hinge holes 616. Consequently, the handle connector 60 is coupled to the cover 20.

Thereafter, the lower end of the support rod 64, which is coupled to the movable rod 65 of the handle rod 63, is inserted into the coupling hole 62 after being aligned with the center of the coupling hole 62. Then, the ball 66′ is pushed inwards by the circumferential inner surface of the coupling hole 62, and part of the ball 66′ is inserted into the through hole 641′.

At this time, the ring spring 65′, which has pushed the ball 66′ outwards in the lower end of the support rod 64, is compressed towards the central axis of the support rod 64 into a shape that is reduced in diameter. When the center of the ball 66′ is aligned with the stop groove 67′, which is formed in the circumferential inner surface of the coupling hole 62, the ring spring 65′, which has been compressed, is returned to the original state thereof, so that the support rod 64 is prevented from being undesirably removed from the coupling hole 62.

Subsequently, when the handle cushion 651 is pulled outwards, the ball 66, which is provided in the upper end of the support rod 64, is retracted into the through hole 641 while compressing the ring spring 65, so that the movable rod 65 enters the state in which it is movable with respect to the support rod 64, thus adjusting the length of the handle rod 63. The movable rod 65 is thereafter fastened to the support rod 64 at a desired position, at which the ball 66, which has been retracted into the through hole 641, is moved outwards and inserted into one of the stop grooves 67, which are formed in the circumferential inner surface of the movable rod 65, by the restoring force of the ring spring 65.

Thereafter, the water supply cap 33 is opened, and a predetermined amount of water is supplied into the water supply tank 30 through the water supply port 32. The water supply cap 33 is reclosed after the water supply process has been completed. A plug, which is not shown in the drawings, is inserted into a wall outlet for the application of power to the heating plate 41.

Here, the water, which is supplied into the water supply tank 30, is drawn into the heating chamber 40 through the supply passage 34 formed through the lower surface of the water supply tank 30. The water, which is drawn into the heating chamber 40, is boiled by heat generated by the heating plate 41, thus generating high temperature steam.

The generated steam moves the central portion in the heating chamber 40 above the boiling water below the water supply tank 30 and thereafter moves upwards through the space between the steam guide duct 11 and the steam discharge duct 31. In this process, because the upper end of the steam discharge duct 31 is closed by the lower end of the stop cap 50, which has a shape that increases in diameter, the steam moves below the main body 10 via the upper end of the steam guide duct 11. Thereafter, the steam is discharged outside through the branch duct 12 and the duster plate 15, which is attached to the main body 10 using the velcro tape 14. Then, the multi-functional cleaner enters the state of being able to conduct a steam-cleaning operation. The user holds the handle cushion 651 and pushes and pulls the cleaner, thus cleaning the floor of a room.

At this time, the temperature of the steam, the amount of water, the amount of generated steam and power are displayed through the display panel 21, which is provided at the predetermined position on the upper surface of the cover 20. Therefore, for example, in the case where the display panel 21 shows that the amount of water is becoming insufficient, the user supplies water into the water supply tank and thereafter conducts the steam-cleaning operation again.

To store the multi-functional cleaner after the steam-cleaning operation has been completed, the user pulls the holding parts 614a of the hinge pins 614 constituting the removable coupling hinges 61 using his/her hands. Then, the coil springs 613 are compressed and the insert ends 614b are removed from the respective hinge holes 616. Thus, the handle connector 60 is easily separated from the cover 20. Then, the user forcibly pulls the support rod 64, which has been coupled to the handle connector 60, so that the support rod 64 is separated from the handle connector 60, thus reducing the volume of the cleaner. Furthermore, the water supply cap 33 and the stop cap 50 are opened, and the cover 20 is turned upside down. Then, remaining water in the water supply tank 30 and the heating chamber 40 is discharged outside to prevent microbes from propagating in the remaining water. The elements separated from each other through the above-mentioned process are placed into and stored in the tub body 10 of the half-tub 80.

Meanwhile, when the user desires to use the half-tub using steam, in the state in which the handle connector 60 is not connected to the cover 20, the water supply cap 33 is opened, and a predetermined amount of water is supplied into the water supply tank. Thereafter, the water supply cap 33 is closed. The stop cap 50, which is exposed outside the upper surface of the over 20, is separated from the steam discharge duct 31. Subsequently, the steam guide cap 70 shown in FIGS. 5 and 8 is coupled to the steam discharge duct 31.

Then, the steam interruption disk 76, which is provided under the lower ends of the extension rods 75 and 75′ that extend downwards from the lower surface of the steam guide cap 70, is brought into close contact with the upper end of the guide duct 11, which protrudes upwards from the central portion in the heating chamber 40, thus preventing steam in the heating chamber 40 from being discharged below the main body 10 through the steam guide duct 11.

As such, because the steam guide duct 11 is in the closed state, the steam in the heating chamber 40 is discharged outside through the open hose connection nipple 74, which is provided on the upper surface of the steam guide cap 70.

Subsequently, the guide hose 71, which is connected to the steam dispersion pipe 85 that is installed in the tub body 10, is connected to the hose connection nipple 74. When the power switch is turned on, power is applied to the heating plate 41, so that high-temperature steam is generated in the same manner as in the steam-cleaning operation. Generated steam moves between the steam guide duct 11 and the steam discharge duct 31 and is discharged outside the hose connection nipple 74 via the extension rods 75 and 75′ of the steam guide cap 70. Steam, which has been passed through the hose connection nipple 74, is discharged upwards into the tub body 10 through the guide hose 71 and the discharge holes 84 and 84′ of the steam dispersion pipe 85, thus making use of the half-tub possible.

Here, when the lever 36 of the adjustment plate 37, which is coupled to the steam discharge duct 31 using the pin 38, is moved to the left or the right, the cross-sectional area of the steam discharge duct 31 is adjusted using the adjustment plate 37, so that the amount of steam supplied into the tub body 10 is adjusted. Furthermore, the temperature of the steam can be adjusted by the temperature controller 871 and the control unit 87, which are provided on the tub body 10. The temperature controller 871 and the control unit 87 are connected to the subsidiary power supply connector 22, which is provided in the cover 20 and is exposed outside, using a typical wire and connector in order to receive power and to transmit control signals.

After the use of the half-tub has been completed, remaining water is removed and the elements of the multi-functional cleaner are stored in the tube body 10, in the above-mentioned manner.

Meanwhile, when it is desired to conduct steam-ironing, the multi-functional cleaner is assembled in the same process as that for the half-tub, and the guide hose 71, which is connected to the iron 90, is fitted over the hose connection nipple 74 shown in FIG. 8. Then, high-temperature steam generated in the heating chamber 40 is supplied into the steam storage body 92 through the guide hose 71. The steam, which is supplied into the steam storage body 92, is discharged outside through the steam discharge holes 93, which are formed through the lower surface of the steam storage body 92, thus enabling clothes to be ironed.

When it is desired to use the multi-functional cleaner as a humidifier that discharges steam into air to control the humidity, the steam guide cap 70′ shown in FIGS. 11 and 12 is coupled to the steam discharge duct 31. Then, high-temperature steam generated in the heating chamber 40 is discharged outside via the joint ball 78, which is fitted into the joint socket 77, and via the nozzle 781, thus controlling the humidity. Because the joint ball 78 is coupled to the joint socket 77 provided on the upper surface of the steam guide cap 70′, the user can change the orientation of the nozzle 781 to point in a desired direction, as shown by the dot-dashed lines of FIG. 12. Therefore, steam can be supplied in a desired direction without changing the orientation of the main body 10 and the cover 20.

After the use of the multi-functional cleaner as the humidifier has been completed, the remaining water is drained and the elements of the multi-functional cleaner are stored in the tub body 10 in the above-mentioned manner.

### INDUSTRIAL APPLICABILITY

As described above, the present invention provides a multi-functional cleaner which can be used as a cleaner by discharging high-temperature steam generated by boiling water, which is supplied into a heating chamber, using the heat of a heating plate provided at a lower position in the heating chamber. Furthermore, in the case where the multi-functional cleaner does not conduct a steam-cleaning function, the multi-functional cleaner can be selectively used as a steam half-tub, a steam iron or a humidifier by changing the direction in which steam is discharged outside.

1. A multi-functional cleaner to generate steam, comprising: a main body (10) having a steam guide duct (11) and coupled to a lower end of a cover (20); a dustcloth plate (15) attached to a lower surface of the main body (10); the cover (20), having a display panel (21) to display an amount or a temperature of water and power, and a subsidiary power supply connector (22); a water supply tank (30) provided between the main body (10) and the cover (20) and provided with a steam discharge duct (31), which protrudes upwards outside an upper surface of the water supply tank (30) and is spaced apart from the steam guide duct (11) in a diametrical direction by a predetermined distance; a heating chamber (40) defined below the water supply tank (30) and having a heating plate (41) therein;
and a stop cap (50) coupled to the steam discharge duct (31), wherein a lower end of the steam guide duct (11) is connected to a branch duct (12) provided at a lower position in the main body (10), so that steam generated in the heating chamber (40) is supplied into the dustcloth plate (15) through the steam discharge duct (31), the steam guide duct (11) and the branch duct (12).

2. The multi-functional cleaner according to claim 1, wherein the stop cap (50) has a shape, which is open at a lower end thereof, an internal thread (51) is formed on a circumferential inner surface of the stop cap (50), a sealing pad (52) is provided at an upper end of the internal thread (51) in the stop cap (50), an extension rod (53), which extends a predetermined length downwards, is integrally provided at a central position under an inner surface of the stop cap (50) which is adjacent to the upper end of the internal thread (51), and a lower part of the extension rod (53) is increased in diameter towards a lower end thereof to have a diameter equal to an inner diameter of the steam discharge duct (31).

3. The multi-functional cleaner according to claim 1, further comprising: a handle connector (60) coupled to opposite ends of the cover (20) using removable coupling hinges (61), with a coupling hole (62) formed in the handle connector (60) so that a handle rod (63) is inserted into the coupling hole (62), wherein each of the removable coupling hinges (61) comprises a hinge pin (614), over which a coil spring (613) is fitted, and which is inserted into a hinge pin insert hole (612) that has a stepped shape and is formed in each of arms (611) provided on opposite ends of the handle connector (60), the hinge pin (614) having a holding part (614a ) on a first end thereof and having an insert end (614b ) on a second end thereof, a compression ring (614c ) integrally provided on the hinge pin (614) at a position adjacent to the insert end (614b ), and a removal prevention ring (615) fitted into the hinge pin insert hole (612), into which the hinge pin (614) is inserted, so that the insert end (614b ), which is exposed outside the removal prevention ring (615), is inserted into each of hinge holes (616) formed in the cover (20).

4. The multi-functional cleaner according to claim 1, wherein the stop cap (50) coupled to the steam discharge duct (31) comprises a steam guide cap (70) connected to a first end of a guide hose (71), and a half-tub (80) or an iron (90) is connected to a second end of the guide hose (71), wherein the steam guide cap (70) has a shape which is open at opposite ends thereof, an internal thread (72) is formed on a circumferential inner surface of the steam guide cap (70), a sealing pad (73) is provided on an upper end of the internal thread (72) in the steam guide cap (70), a hollow hose connection nipple (74) is provided through an upper end of the steam guide cap (70), a plurality of extension rods (75) and (75′), which extend predetermined lengths downwards and are spaced apart from each other at regular angular intervals, is provided at a central portion under an inner surface of the steam guide cap (70) which is adjacent to an upper end of the internal thread (72), and a steam interruption disk (76) is integrally provided under lower ends of the extension rods (75) and (75′).

5. The multi-functional cleaner according to claim 4, wherein the half-tub (80) comprises a tub body (81) having a box shape, which is open at an upper end thereof, with a tub cover coupled to an upper end of the tub body (81) using hinges (82) and (82′), a steam dispersion pipe (85) having a plurality of discharge holes (84) and (84′) and provided along a perimeter of a bottom of the tub body (81) while an inlet of the steam dispersion pipe (85) is exposed outside an insertion hole (811), which is formed at a lower position through the tub body (81), and is connected to the guide hose (71), a footstep (86) placed inside the steam dispersion pipe (85) in the tube body (81), and a control unit (87) having a temperature controller (871) provided on the tube body (81), the control unit (87) being connected to the subsidiary power supply connector (22) provided in the cover (20).

6. The multi-functional cleaner according to claim 4, wherein the iron (90) comprises an iron body (91) provided with a handle (94), and a steam storage body (92) installed in the iron body (91), wherein a plurality of steam discharge holes (93) is formed through lower surfaces of the iron body (91) and the steam storage body (92), and each of the steam discharge holes (93) has a shape which is increased in diameter from an upper position to a lower position thereof.

7. The multi-functional cleaner according to claim 1, wherein the stop cap (50) coupled to the steam discharge duct (31) comprises a steam guide cap (70′) having a shape which is open at a lower end thereof, wherein an internal thread (72) is formed on a circumferential inner surface of the steam guide cap (70′), a sealing pad (73) is provided on an upper end of the internal thread (72) in the steam guide cap (70′), a joint socket (77), having a hollow shape that is increased in diameter to an intermediate position thereof, is provided on an upper surface of the steam guide cap (70′), and a joint ball (78) provided with a nozzle (781) is inserted into the joint socket (77).
